(19) United States
(12) Patent Application Publication
(10) Pub. No.: US 2005/0236853 A1
(43) Pub. Date: Oct. 27, 2005

(54) Hand-held hinged device for manipulating objects

(76) Inventors: Pam C. Demetroulakos, Marblehead, MA (US); James L. Demetroulakos, Marblehead, MA (US); Michael G. Chamberas, New York, NY (US)

Correspondence Address: PEARSON & PEARSON, LLP, 10 GEORGIA STREET, LOWELL, MA, 01852, US

(21) Appl. No.: 11/106,197

(22) Filed: Apr. 14, 2005

Related U.S. Application Data
(60) Provisional application No. 60/563,149, filed on Apr. 19, 2004.

(51) Int. Cl. A47J 43/28

(52) U.S. Cl. 294/99.2

(57) ABSTRACT

A device for manipulating objects, including, but not limited to food, by squeezing a pair of hinged jaws together so as to grasp the desired object by placing gentle pressure on a flat portion of each of the jaws and closing the jaws around the object. This allows the user to grasp the object, and by easing the pressure, releases the object when at its desired location. The two hinged jaws are each generally concavo-convex in shape with an elongated end which tapers to a point. The hinge is a non-removable part that allows the device to open and close without separating. The device is normally open when not in use and closed when the two sides are pressed together. The device can be held easily in the hand of an adult, a child, or a handicapped person.

### CROSS-REFERENCE TO RELATED APPLICATIONS

This is a nonprovisional patent application claiming priority of provisional application for patent No. 60/563,149, filed Apr. 19, 2004, the complete subject matter of which is incorporated herein by reference in its entirety.

### BACKGROUND OF THE INVENTION

1. Field of the Invention

This invention relates generally to a hand-held gripping devices, and more particularly to a simpler hand-held hinged device for grasping and manipulating food or other objects by an adult or a child.

2. Description of Related Art

People with limited dexterity such as small children, the elderly and handicapped have difficulty grasping and lifting small objects which may result in difficulty bringing food to their mouth.

The following U.S. patents show the status of the prior art for hand-held gripping devices:

U.S. Pat. No. 580,148, issued Apr. 6, 1897 to Elial M. Staples discloses a holder comprising a body composed of a plurality of layers of nonconducting paper, stitched together to form a permanently-curved body which automatically resumes its normal shape when bent either inwardly or outwardly, and a piece of fiber is stitched to the inner side of the body. Another piece of cotton or felt is stitched on the outside to form pockets to protect fingers, etc. However, the size of the holder is too large for children, and it is mainly intended for use on the handle of a flat-iron, teapot or other hot items.

U.S. Pat. No. 3,610,670, issued Oct. 5, 1971 to Karl M. Keck (which is a Division of U.S. Pat. No. 3,412,464) discloses a holder 1 having a pair of jaws for safety razor blade carriers or other objects such as tools, manicuring implements, toilet articles, etc. It has one piece construction composed of suitable plastic material The holder comprises a central web or spine formed with a pair of jaws defining a substantially cylindrical groove or channel between the jaws. Extending laterally and integrally from the web or spine of the holder are two wings of a clamshell formation, and that are connected to the spine or web by means of integral thin hinge elements or webs on which the wings are pivotal in a manner to bring them into a position where they cover and protect the jaws 3 and object held between the jaws 3. The wings 9 may be turned inside out or reversed. However, the closure on the rounded ends would get in the way of picking up the object, which would probably have to be put into it by hand, rather than grasped. Because the interior is not hollowed out, the device could not be used to scoop more than one item at once.

U.S. Pat. No. 3,975,043, issued Aug. 17, 1976 to Leslie John Miles discloses a gripping device for holding a fish comprising a pair of similar elongated side assemblies joined pivotally together at their inner edges by means of a longitudinally extending hinge assembly. The left hand assembly is provided on the inside with inwardly and upwardly directed ridges while the right-hand assembly has those corresponding sections. These ridges are adapted to deform the fish to ensure non-slip gripping thereon. However, the torsion bar spring assembly is a removable part which would be a possible safety concern. It would also be a place for debris and bacteria to collect. Because it is cylindrical in shape the ends, even when closed, leave an opening so that the object being grasped could not be completely encapsulated.

U.S. Pat. No. 4,523,781, issued Jun. 18, 1985 to Hal Brody discloses a semi-flexible gripping aid for a person with a manual or digital disability to enable a person to grasp a large semi-flexible body which in turn contains a thin instrument such as a knife, or pen or toothbrush. The aid comprises two half-shells hinged together at one edge to clamshell together with a pair of hinged straps. However, the whole hand must be used to manipulate the device rather than just two fingers. There are too many holes and spaces for debris to collect. The design is not streamline, or without moveable parts.

U.S. Design Pat. No. 368,330, issued Mar. 26, 1996 to Florida C. Robinson and assigned to Williamson Enterprises of Santa Monica, Calif. discloses a thermal insulating finger pad having a slot on an end for a thumb to fit in and a pouch on the other end for the fingers to fit into to facilitate grasping an object. However, too many fingers need to be used to manipulate this device. The area which the fingers and thumb occupy are not areas that can be easily kept clean. The ends are not tapered enough to allow for easy grasping of objects.

U.S. Pat. No. 5,607,196, issued Mar. 4, 1997 to Kenneth J. Weger discloses a hand-held gripping device comprising a unitary hollow body with an open end having a general shape of a prolate spheroid (i.e., a football shape) with a longitudinal lune removed therefrom to form a mouth with two generally arcuate edges. The body is preferably a type of resilient plastic. The hollow body forms two convex side surfaces. When the side surfaces of the body are compressed by the fingers of a user's hand, the entire resilient body is deformed by the compressional forces, and the two side surfaces curl towards each other, thereby tending to cause the mouth to close. Preferably, the mouth can be fully closed by this operation. Accordingly, the device can be used to pick up small objects, such as pills, coins, paper clips, etc., that can be captured in the body of the device or that can be held by the lip portions of a partially closed mouth. However, the opening in the top would allow objects to escape, and the side surfaces of the body have to be compressed by a user's fingers which require forces that may not be appropriate for a child or those with dexterity concerns. U.S. Pat. No. 6,145,128 issued Nov. 14, 2000 to Eriko Suzuki discloses a finger protector apparatus having a hinge portion, a thumb portion and two finger receiving portions. The finger protector apparatus can be worn by a person who wishes to pick-up oily finger foods such as potato chips. However, the “cup” design where the fingers insert provides places for debris and bacteria to collect. It does not close around the objects that are being picked up. For someone of limited or developing dexterity, it does not provide an easier method for grasping the desired object.

### SUMMARY OF THE INVENTION

Accordingly, it is therefore an object of this invention to provide a hand-held hinged device which is normally opened and facilitates the grasping and manipulating of objects.

It is another object of this invention to provide a hand-held hinged device which facilitates the grasping and manipulating of objects and allows the user to grasp and pick up objects with the use of a thumb and a finger.

It is another object of this invention to provide a hand-held hinged device that may be used as an eating utensil to enable food to be brought to the mouth of a user such as a child or a handicapped person with more ease than with any other conventional eating utensils.

It is a further object of this invention to provide a hand-held hinged device which will facilitate the grasping and manipulating of objects and may be used as an exercise tool for developing hand-eye coordination or to develop or exercise fine motor skills.

These and other objects are further accomplished by a device for grasping and manipulating objects comprising a first jaw having a generally concavo-convex shape, a second jaw adjacent to the first jaw having a generally concavo-convex shape, and means for connecting the first jaw to the second jaw wherein the first jaw and the second jaw are normally in an open position. Each of the first jaw and the second jaw having a generally concavo-convex shape comprises an elongated end which tapers to a point. The first jaw and the second jaw each comprises a flat area on an outer side near the point for positioning a finger of a user's hand. The first jaw and the second jaw each comprises curved ridges around the flat area on the outer side to facilitate gripping of the device. The connecting means comprises a hinge. The hinge is formed between adjacent edges of the first jaw and the second jaw. The hinged device is made of plastic material including thermoplastic urethane.

The objects are further accomplished by a method of providing a device for grasping and manipulating objects comprising the steps of providing a first jaw having a generally concavo-convex shape, providing a second jaw adjacent to the first jaw having a generally concavo-convex shape, connecting the first jaw to the second jaw wherein the first jaw and the second jaw are normally in an open position. The step of providing a concavo-convex shape first jaw and the second jaw comprises the step of providing each of the first jaw and the second jaw with an elongated end that tapers to a point. The step of providing a concavo-convex first jaw and the second jaw comprises the step of providing a flat area on an outer surface for positioning a finger of a user's hand. The step of providing a concavo-convex first jaw and second jaw comprises the step of providing curved ridges around the flat area on the outer side which facilitates gripping of the device. The step of connecting the first jaw to the second jaw comprises the step of providing a hinge between adjacent edges of the first jaw and the second jaw. The method comprises the step of forming the hinged device in a predetermined mold for inserting a plastic material including thermoplastic urethane.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a top view of a hand-held hinged device in a normally open position which facilitates the grasping and manipulating of objects according to the present invention;

FIG. 2 is a top view of a hand-held hinged device in a closed position which facilitates the grasping and manipulating of objects according to the present invention;

FIG. 3 is a side elevational view of a hand-held hinged device in a closed position which facilitates the grasping and manipulating of objects;

FIG. 4 is a front view of a hand-held hinged device in a partially open position which facilitates the grasping and manipulating of objects;

FIG. 5 is a front view of a hand-held hinged device in a closed position which facilitates the grasping and manipulating of objects;

FIG. 6 is an inside view of a hand-held hinged device in a normally open position;

FIG. 7 is a cross-sectional view of the hand-held hinged device of FIG. 1 taken along lines 7-7 showing the device in a normally open position and in a partially closed position; and

FIG. 8 is a cross-sectional view of the jaw 12 of FIG. 3 taken along lines 8-8.

### DESCRIPTION OF ILLUSTRATIVE EMBODIMENT

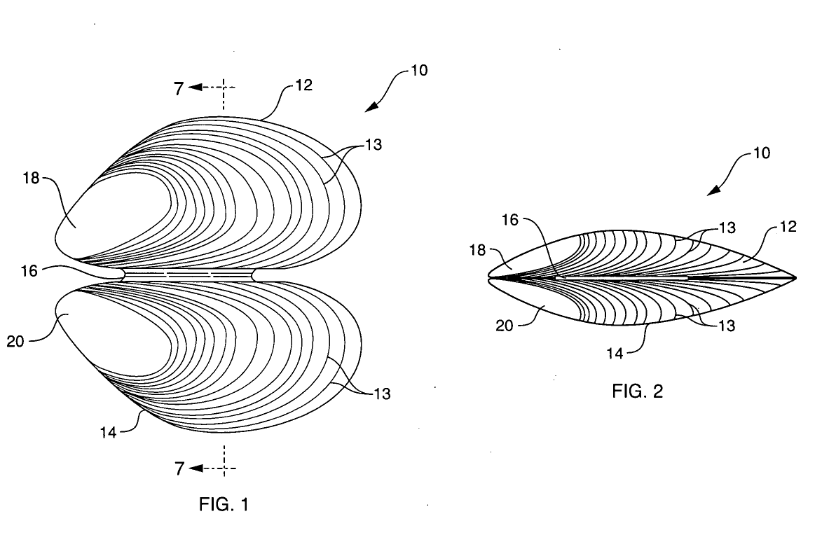

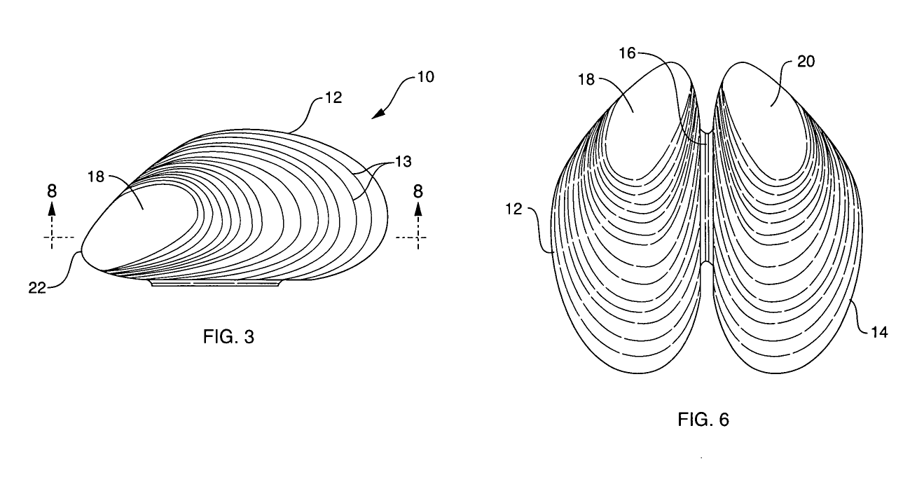

Referring to FIG. 1 and FIG. 2, FIG. 1 is a hand-held hinged device 10 in a normally open position according to the present invention, and the hinged device 10 is used for facilitating the grasping and manipulating of objects. FIG. 2 is a top view of the hinged device 10 of FIG. 1 in a closed position according to the present invention.

The hinged device 10 comprises two jaws 12, 14 connected by a non-removable flexible hinge 16 that allows them to be brought together in response to external force by a user in such a way, as shown in FIG. 2, that objects may be grasped or contained within the jaws 12, 14. The hinged device 10 is open when not in use and closed about the flexible hinge 16 when the two jaws 12, 14 are pressed together by the user's thumb and another finger or fingers.

Referring to FIG. 2 and FIG. 3, FIG. 3 is a side elevational view of the hand-held hinged device 10 shown in the closed position. The jaw 12 is generally oval having a concavo-convex or “clamshell” shape and an elongated end which tapers to a point 22. Each jaw 12, 14 comprises a flat area 18, 20 to facilitate placement of a thumb and finger(s) to supply the force to close the jaws 12, 14, when operating the hinged device 10. The remaining outer surface of each jaw 12, 14 comprises curved ridges 13 which help to locate finger placement on the flat area 18, 20 and also provide a non-smooth surface for ease of gripping the device 10. The ridges 13 further provide a decorative effect. The size of device 10 may vary, but in the preferred embodiment it has a size which can be easily held in the hand of an adult, a child, or a handicapped person.

Each jaw 12, 14 has a length of approximately 2⅞ inches and a width of approximately 1⅜ inches at its longest and widest points. The flexible hinge 16 is approximately 1¼ inch long and each side of the hinge 16 is made integral with an adjacent side of the jaws 12, 14 edges. The hinge 16 has an inverted V-shape with the V portion extending away from the jaws 12, 14 in FIG. 1 (or out of the page). This hinge arrangement provides for the hinged device 10 or jaws 12, 14 to be open when not in use. One of ordinary skill in the art will recognize that many other dimensions of the hinged device 10 may be implemented which come within the spirit of this invention and the scope of the claims.

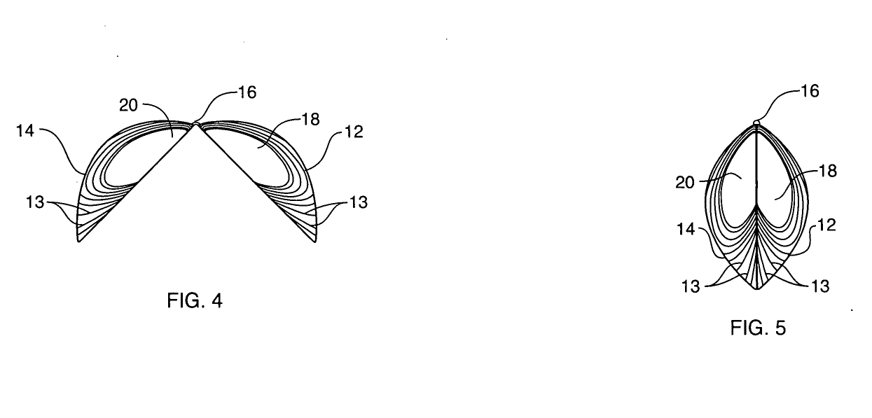

Referring to FIG. 4 and FIG. 5, FIG. 4 is a front view of the hand-held hinged device 10 in a partially open position showing the two jaws 12, 14 forming approximately a 90 degree angle connected by an integral hinge 16. FIG. 5 is a front view of the hinged device 10 in a fully closed position having the flat areas 18, 20 at the upper portions of jaws 12 and 14.

Referring to FIG. 6, an inside view of the hinged device 10 shows the two jaws 12, 14 having concave inside surfaces which provide space for an object to be retained when enclosed by the jaws 12, 14.

Referring to FIGS. 1, 2, and 6, the hinged device 10 including the hinge 16 is made from resilient plastic material such as thermoplastic urethane (TPU) having a shore D 60-70, and the hinge 16 is an integral part of jaws 12 and 14. The hinged device 10 is made in a mold which is known to one of ordinary skill in the art and into which the TPC material is inserted to form the hinged device 10. The hinge 16 between jaws 12 and 14 extends along the adjacent edges of jaws 12 and 14 for a distance of approximately 1¼ inches, and as previously described, the hinge 16 has an inverted V-shape.

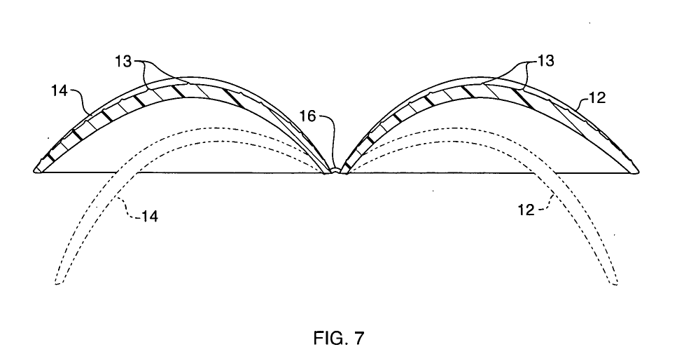

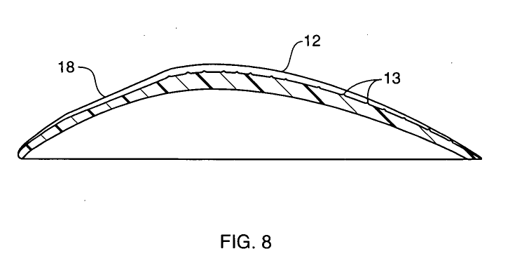

Referring to FIG. 7 and FIG. 8, FIG. 7 is a cross-sectional view of the hand held hinged device 10 of FIG. 1 taken along lines 7-7, and FIG. 7 shows the hinged device 10 in the normally open position and in a partially closed position (dashed lines) when pressure is applied by a user to the sides of jaws 12, 14. FIG. 8 is a cross-sectional view of the jaw 12 of FIG. 3 taken along lines 8-8 showing the flat portion 18 of the jaw 12. The jaws 12, 14 are approximately ⅛ inch thick at the middle of each jaw 12, 14 and taper to approximately 1/16 inch thick at the end points of the jaws 12, 14 in the present preferred embodiment. The jaws 12, 14 with the above dimensions are resilient to facilitate grasping and manipulating objects. The above dimensions are representative of the preferred embodiment, but the invention may be embodied by various other dimensions and still come within the scope of the claims.

The hinged device 10 is intended to facilitate the grasping and manipulating of objects, and device 10 may be used as an eating utensil. Device 10 may be used as a toy, and it may also be used as a rehabilitation tool for patients who have lost fine motor coordination.

This invention has been disclosed in terms of certain embodiment. It will be apparent that many modifications can be made to the disclosed apparatus without departing from the invention. Therefore, it is the intent of the appended claims to cover all such variations and modifications as come within the true spirit and scope of this invention.

1. A device for grasping and manipulating objects comprising:
a first jaw having a generally concavo-convex shape;
a second jaw adjacent to said first jaw having a generally concavo-convex shape; and
means for connecting said first jaw to said second jaw wherein said first jaw and said second jaw are normally in an open position and are closed by a user about said connecting means.

2. The device as recited in claim 1 wherein each of said first jaw and said second jaw having a generally concavo-convex shape comprises an elongated end which tapers to a point.

3. The device as recited in claim 2 wherein said first jaw and said second jaw each comprises a flat area on an outer side near said point for positioning a finger of a user's hand.

4. The device as recited in claim 3 wherein said first jaw and said second jaw each comprises curved ridges around said flat area on said outer side to facilitate gripping of said device.

5. The device as recited in claim 1 wherein said connecting means comprises a flexible hinge.

6. The device as recited in claim 5 wherein said hinge is formed between adjacent edges of said first jaw and said second jaw.

7. The device as recited in claim 1 wherein said hinged device is made of plastic material including thermoplastic urethane.

8. A method of providing a device for grasping and manipulating objects comprising the steps of:
providing a first jaw having a generally concavo-convex shape;
providing a second jaw adjacent to said first jaw having a generally concavo-convex shape;
connecting the first jaw to said second jaw with a flexible hinge wherein said first jaw and said second jaw are normally in an open position and are closed by a user for grasping and manipulating objects.

9. The method as recited in claim 8 wherein the step of providing a concavo-convex shape first jaw and said second jaw comprises the step of providing each of said first jaw and said second jaw with an elongated end that tapers to a point.

10. The method as recited in claim 9 wherein said step of providing a concavo-convex first jaw and said second jaw comprises the step of providing a flat area on an outer surface for positioning a finger of a user's hand.

11. The method as recited in claim 10 wherein said step of providing a concavo-convex first jaw and second jaw comprises the step of providing curved ridges around said flat area on said outer side which facilitates gripping of said device.

12. The method as provided in claim 8 wherein the step of connecting said first jaw to said second jaw comprises the step of providing a hinge between adjacent edges of said first jaw and said second jaw.

13. The method as recited in claim 8 wherein said method comprises the step of forming said hinged device in a predetermined mold for inserting a plastic material including thermoplastic urethane.
